(19) United States
(12) Patent Application Publication
(10) Pub. No.: US 2022/0026239 A1
(43) Pub. Date: Jan. 27, 2022

(54) MACHINE PART FOR LASER DEMARCATION DEVICE

(71) Applicant: CHANGZHOU MIDEKER OPTOELECTRONIC TECHNOLOGY CO., LTD., CHANGZHOU CITY (CN)

(72) Inventor: JIAN LU, CHANGZHOU CITY (CN)

(21) Appl. No.: 16/939,648

(22) Filed: Jul. 27, 2020

(51) Int. Cl. G01C 25/00; G01C 15/00

(52) U.S. Cl. CPC G01C 25/00; G01C 15/004

(57) ABSTRACT

A machine part for laser demarcation device is provided, including: a hanger, a pendulum, a first shaft and a second shaft, in which a first wire threading hole is provided on central location of the first shaft along radial direction thereof, and both ends of the first shaft are rotatably supported on the hanger through bearings; a second wire threading hole is provided on center position of the second shaft along radial direction thereof, the second shaft is fixedly connected to the first shaft, the first and second wire threading holes are aligned, and the axial directions of the first and second shafts are perpendicular; and two connecting arms are symmetrically provided on an upper end of the pendulum body, the connecting arms correspond to the ends of the second shaft, and the connecting arms are rotatably mounted on the corresponding ends of the second shaft through bearings.

### FIELD OF THE DISCLOSURE

The present disclosure relates to a machine part for laser demarcation device.

### BACKGROUND OF THE DISCLOSURE

The laser demarcation device is a laser that projects the horizontal and vertical reference lines or reference points accurately on the work object, so that the workers can work with the reference line during construction without deviating from their expected position. The laser demarcation device has a movement, and the pendulum body of the movement swings within a certain range, and finally reaches the equilibrium state under the action of gravity. The laser mounted on the pendulum body needs to be electrically connected to the control circuit fixed on the casing of the laser demarcation device by wires, but the wires will affect the position of the pendulum body in a free balance state, causing the pendulum body to not reach the ideal position, thus resulting in the deviation of the projected position of the light emitted by the laser and affecting the accuracy of the entire laser demarcation device.

### SUMMARY OF THE DISCLOSURE

The technical problem to be solved by the present disclosure is to overcome the shortcomings of the prior art, and to provide a machine part for laser demarcation device, whose pendulum can swing freely under the action of gravity, and a first wire threading hole and a second wire threading hole are provided to minimize the impact of the wire on the pendulum body, thereby improving the accuracy of the laser demarcation device.

In order to solve the above technical problems, the technical solution of the present disclosure is to provide a machine part for laser demarcation device, including: a hanger, a pendulum, a first shaft and a second shaft, in which a first wire threading hole is provided on a central location of the first shaft along a radial direction of the first shaft, and both ends of the first shaft are rotatably supported on the hanger through bearings; a second wire threading hole is provided on a center position of the second shaft along a radial direction of the second shaft, the second shaft is fixedly connected to the first shaft, the second wire threading hole is aligned with the first wire threading hole, and an axial direction of the second shaft is perpendicular to an axial direction of the first shaft; and two connecting arms are symmetrically provided on an upper end of the pendulum body, the connecting arms correspond to the ends of the second shaft, respectively, and the connecting arms are rotatably mounted on the corresponding ends of the second shaft through bearings.

In a preferred embodiment, an insertion hole perpendicular to the first wire threading hole is provided on the central position of the first shaft along the radial direction of the first shaft, and the second shaft passes through the insertion hole; or the insertion hole perpendicular to the second wire threading hole is provided on the central position of the second shaft along the radial direction of the second shaft, and the first shaft passes through the insertion hole.

In a preferred embodiment, the first shaft and the second shaft are fixed by glue.

In a preferred embodiment, the insertion hole perpendicular to the second wire threading hole is provided on the center position of the second shaft along the radial direction of the second shaft, and the first shaft passes through the insertion hole; and a position-limiting member is provided on the first shaft for contacting the second shaft when the first wire threading hole is aligned with the second wire threading hole.

In a preferred embodiment, a fixing member, which abuts on a side of a far position-limiting member of the second shaft, is detachably connected to the first shaft, and the fixing member and the position-limiting member clamp the second shaft.

In a preferred embodiment, an inner ring of the bearings mounted on the first shaft is fixed to the first shaft by glue and/or an inner ring of the bearings mounted on the second shaft is fixed to the second shaft by glue.

In a preferred embodiment, an inner ring of the bearings mounted on the first shaft is fixedly connected to the first shaft through a bearings pressure ring and/or an inner ring of the bearings mounted on the second shaft is fixedly connected to the second shaft through the bearings pressure ring.

In a preferred embodiment, the corresponding bearings pressure ring is connected to the first shaft by threads and/or the corresponding bearings pressure ring is connected to the second shaft by threads.

In a preferred embodiment, an outer ring of the corresponding bearings is fixed to the hanger by glue and/or an outer ring of the corresponding bearings is fixed to the connecting arms by glue.

In a preferred embodiment, a hole for glue dropping is provided on the hanger and/or the connecting arms for communicating with a corresponding bearings mounting hole for mounting the bearings.

After adopting the above technical solution, the pendulum body of the present disclosure can swing around the shaft line of the first shaft and the shaft line of the second shaft under the action of gravity, and finally reach a state of equilibrium. One end of the wire of the laser demarcation device is fixed to the control circuit fixed on the casing of the laser demarcation device, and the other end passes through the second wire threading hole and the first wire threading hole and then is connected to the laser fixed on the pendulum. By means of the arrangement of the first wire threading hole and the second wire threading hole, the present disclosure can minimize the influence of the electric wire on the pendulum body, so that the pendulum body can be placed in the most ideal position in a balanced state, thereby improving the accuracy of the laser demarcation device. In the process of assembling the machine part for laser demarcation device, the bearings are first mounted on both ends of the second shaft, then the second shaft assembled with the bearings and the connecting arms of the pendulum body are assembled, and the second shaft and the inner ring of the corresponding bearings can be glued or fixed by the bearings pressure ring. The connecting arms and the outer ring of the corresponding bearings can be glued to place the second shaft assembled with the pendulum body in the center of the hanger, the first shaft is inserted into the insertion holes on the hanger and the second shaft, the bearings are mounted on both ends of the first shaft, the hanger and the outer ring of the corresponding bearings can be fixed by glue, the first shaft and the inner ring of the corresponding bearings can be glued, or fixed by the bearings pressure ring, then the second shaft is moved to make the second wire threading hole align with the first wire threading hole, and the first shaft and the second shaft are fixed by glue to complete the assembly of the entire machine part for laser demarcation device. The assembly process is simple, convenient, and the assembly efficiency is high.

### BRIEF DESCRIPTION OF THE DRAWINGS

FIG. 1 is a schematic diagram of the structure of the machine part for laser demarcation device of the present disclosure.

FIG. 2 is an exploded view of FIG. 1.

### DETAILED DESCRIPTION OF THE EXEMPLARY EMBODIMENTS

In order to make the content of the present disclosure more clearly understood, the present disclosure will be further described in detail based on specific embodiments and the accompanying drawings.

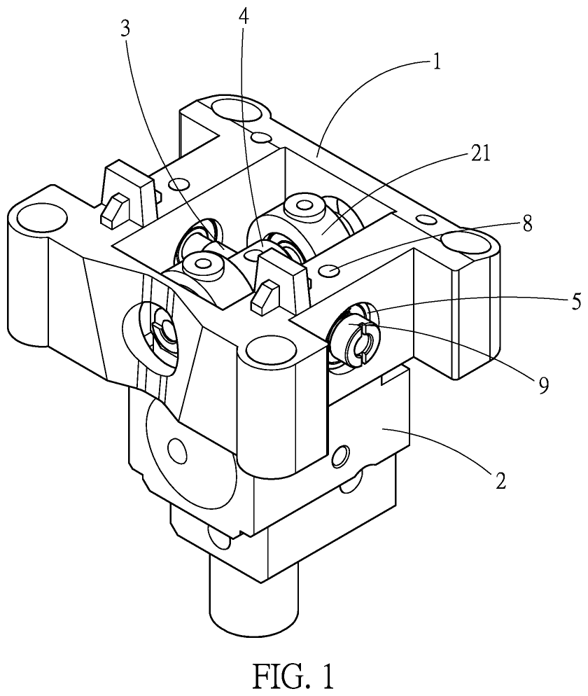

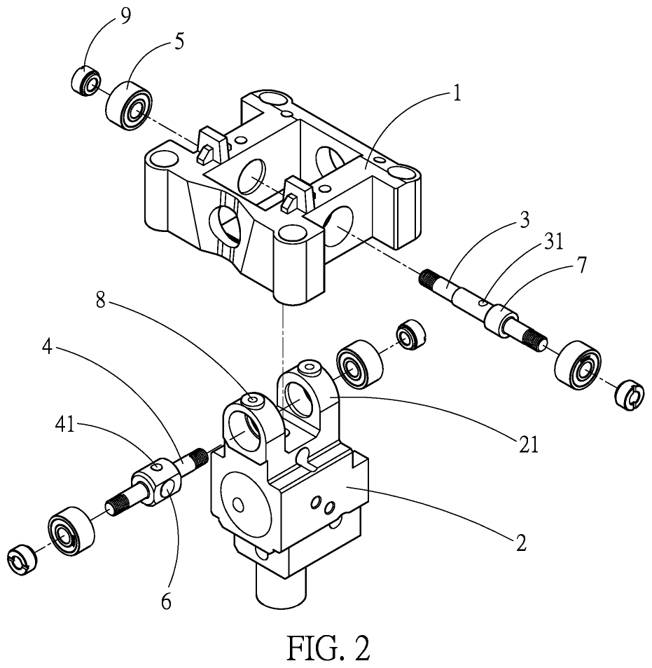

As shown in FIG. 1 and FIG. 2, a machine part for laser demarcation device is provided, including: a hanger 1, a pendulum 2, a first shaft 3 and a second shaft 4, in which a first wire threading hole 31 is provided on a central location of the first shaft 3 along a radial direction of the first shaft 3, and both ends of the first shaft 3 are rotatably supported on the hanger 1 through bearings 5; a second wire threading hole 41 is provided on a center position of the second shaft 4 along a radial direction of the second shaft 4, the second shaft 4 is fixedly connected to the first shaft 3, the second wire threading hole 41 is aligned with the first wire threading hole 31, and an axial direction of the second shaft 4 is perpendicular to an axial direction of the first shaft 3; and two connecting arms 21 are symmetrically provided on an upper end of the pendulum body 2, the connecting arms 21 correspond to the ends of the second shaft 4, respectively, and the connecting arms 21 are rotatably mounted on the corresponding ends of the second shaft 4 through bearings 5.

The pendulum body 2 of the present disclosure can swing around the shaft line of the first shaft 3 and the shaft line of the second shaft 4 under the action of gravity, and finally reaches a state of equilibrium. One end of the electric wire of the laser demarcation device is fixed to the control circuit fixed on the casing of the laser demarcation device, and the other end passes through the second wire threading hole 41 and the first wire threading hole 31 and then is connected to the laser fixed on the pendulum body 2. By means of the arrangement of the first wire threading hole 31 and the second wire threading hole 41, the present disclosure can minimize the influence of the electric wire on the pendulum body 2, so that the pendulum body 2 can be placed in the most ideal position in a balanced state, thereby improving the accuracy of the laser demarcation device.

As shown in FIG. 1 and FIG. 2, an insertion hole 6 perpendicular to the first wire threading hole 31 is provided on the central position of the first shaft 3 along the radial direction of the first shaft 3, and the second shaft 4 passes through the insertion hole 6; or the insertion hole 6 perpendicular to the second wire threading hole 41 is provided on the central position of the second shaft 4 along the radial direction of the second shaft 4, and the first shaft 3 passes through the insertion hole 6.

In the present embodiment, the insertion hole 6 perpendicular to the second wire threading hole 41 is provided on the center position of the second shaft 4 along the radial direction of the second shaft 4, and the first shaft 3 passes through the insertion hole 6. For the convenience of aligning the first wire threading hole 31 and the second wire threading hole 41, a position-limiting member 7 is provided on the first shaft 3 for contacting the second shaft 4 when the first wire threading hole 31 is aligned with the second wire threading hole 41.

In the present embodiment, the first shaft 3 and the second shaft 4 are fixed by glue, and a fixing member, which abuts on a side of a far position-limiting member of the second shaft 4, is detachably connected to the first shaft 3, and the fixing member and the position-limiting member 7 clamp the second shaft 4.

Specifically, in the process of assembling the machine part for laser demarcation device, the bearings 5 are first mounted on both ends of the second shaft 4, then the second shaft 4 assembled with the bearings 5 and the connecting arms 21 of the pendulum body 2 are assembled, and the second shaft 4 and the inner ring of the corresponding bearings 5 can be glued or fixed by the bearings pressure ring 9. The connecting arms 21 and the outer ring of the corresponding bearings 5 can be glued to place the second shaft 4 assembled with the pendulum body 2 in the center of the hanger 1, the first shaft 3 is inserted into the hanger 1 and the insertion holes 6 on the second shaft 4, the bearings 5 are mounted on both ends of the first shaft 3, the hanger 1 and the outer ring of the corresponding bearings 5 can be fixed by glue, the first shaft 3 and the inner ring of the corresponding bearings 5 can be glued, or fixed by the bearings pressure ring 9, then the second shaft 4 is moved to make the second wire threading hole 41 align with the first wire threading hole 31, and the first shaft 3 and the second shaft 4 are fixed by glue to complete the assembly of the entire machine part for laser demarcation device. The assembly process is simple, convenient, and the assembly efficiency is high.

In the present embodiment, an inner ring of the bearings 5 mounted on the first shaft 3 is fixed to the first shaft 3 by glue and/or an inner ring of the bearings 5 mounted on the second shaft 4 is fixed to the second shaft 4 by glue; or an inner ring of the bearings 5 mounted on the first shaft 3 is fixedly connected to the first shaft 3 through a bearing pressure ring 9 and/or an inner ring of the bearings 5 mounted on the second shaft 4 is fixedly connected to the second shaft 4 through the bearings pressure ring 9. The corresponding bearings pressure ring 9 is connected to the first shaft 3 by threads and/or the corresponding bearings pressure ring 9 is connected to the second shaft 4 by threads.

In the present embodiment, an outer ring of the corresponding bearings 5 is fixed to the hanger 1 by blue and/or an outer ring of the corresponding bearings 5 is fixed to the connecting arms 21 by glue.

As shown in FIG. 1 and FIG. 2, for convenience of dropping glue, a hole 8 for glue dropping is provided on the hanger 1 and/or the connecting arms 21 for communicating with a corresponding bearings mounting hole for mounting the bearings 5.

The specific embodiments described above provide further detailed descriptions of the technical problems, technical solutions and beneficial effects of the present disclosure. It should be understood that the above are only specific embodiments of the present disclosure and are not intended to be used to restrict the present disclosure, and any modification, equivalent replacement, improvement, etc. made within the spirit and principle of the present disclosure should be included in the protection scope of the present disclosure.

In the description of the present disclosure, it should be understood that the term indicating the orientation or positional relationship is based on the orientation or positional relationship shown in the drawings, which only to facilitate the description of the present disclosure and simplify the description, not to indicate or imply that the device or element referred to must have a specific orientation, be constructed and operated in a specific orientation, and therefore cannot be understood as a limitation of the present disclosure.

In the present disclosure, unless otherwise clearly specified and defined, the terms “mounted”, “connecting”, “connected”, “fixed” and other terms should be understood in a broad sense, for example, it can be fixed or detachable connection or integration; it can be mechanical connection or electrical connection; it can be directly connected or indirectly connected through an intermediary. It can be the connection between two components or the interaction between two components. For those of ordinary skill in the art, the specific meanings of the above terms in the present disclosure can be understood according to specific situations.

In the description of the present disclosure, it should be noted that the terms “center”, “upper”, “lower”, “left”, “right”, “perpendicular”, “horizontal”, “inner”, “outer” or position relationship indicated is based on the azimuth or position relationship shown in the drawings, or the azimuth or position relationship habitually placed when the product the present disclosure is used, which only to facilitate the description of the present disclosure and simplify the description, not to indicate or suggest that the device or element referred to must have a specific orientation, be constructed and operated in a specific orientation, and therefore cannot be understood as a limitation of the present disclosure. In addition, the terms “first”, “second”, “third”, etc. are only used to distinguish the description, and cannot be understood as indicating or implying relative importance.

In addition, the terms “horizontal”, “perpendicular”, “overhanging” and the like do not mean that the components are required to be absolutely horizontal or overhanging, but may be slightly inclined. For example, “horizontal” only means that its direction is more horizontal than “perpendicular”, it does not mean that the structure must be completely horizontal, but it can be slightly inclined.

In the present disclosure, unless otherwise clearly specified and defined, the first feature above or below the second feature may include the first feature direct contacting the second feature, or may also include that the first and second features are not in direct contact but are in contact with another feature between them. Moreover, the first feature on, above and upon the second feature includes that the first feature is directly above and obliquely above the second feature, or simply means that the first feature is higher in level than the second feature. The first feature is below, underneath, and under the second feature, including that the first feature is directly below and obliquely below the second feature, or simply means that the first feature is less horizontal than the second feature.

What is claimed is:

1. A machine part for laser demarcation device, comprising: a hanger (1), a pendulum (2), a first shaft (3) and a second shaft (4), wherein
a first wire threading hole (31) is provided on a central location of the first shaft (3) along a radial direction of the first shaft (3), and both ends of the first shaft (3) are rotatably supported on the hanger (1) through bearings (5);
a second wire threading hole (41) is provided on a center position of the second shaft (4) along a radial direction of the second shaft (4), the second shaft (4) is fixedly connected to the first shaft (3), the second wire threading hole (41) is aligned with the first wire threading hole (31), and an axial direction of the second shaft (4) is perpendicular to an axial direction of the first shaft (3); and
two connecting arms (21) are symmetrically provided on an upper end of the pendulum body (2), the connecting arms (21) correspond to the ends of the second shaft (4), respectively, and the connecting aims (21) are rotatably mounted on the corresponding ends of the second shaft (4) through bearings (5).

2. The machine part for laser demarcation device according to claim 1,
wherein
an insertion hole (6) perpendicular to the first wire threading hole (31) is provided on the central position of the first shaft (3) along the radial direction of the first shaft (3), and the second shaft (4) passes through the insertion hole (6); or
the insertion hole (6) perpendicular to the second wire threading hole (41) is provided on the central position of the second shaft (4) along the radial direction of the second shaft (4), and the first shaft (3) passes through the insertion hole (6).

3. The machine part for laser demarcation device according to claim 2, wherein the first shaft (3) is fixed to the second shaft (4) by glue.

4. The machine part for laser demarcation device according to claim 1, wherein
the insertion hole (6) perpendicular to the second wire threading hole (41) is provided on the center position of the second shaft (4) along the radial direction of the second shaft (4), and the first shaft (3) passes through the insertion hole (6); and
a position-limiting member (7) is provided on the first shaft (3) for contacting the second shaft (4) when the first wire threading hole (31) is aligned with the second wire threading hole (41).

5. The machine part for laser demarcation device according to claim 4, wherein
a fixing member, which abuts on a side of a far position-limiting member of the second shaft (4), is detachably connected to the first shaft (3), and the fixing member and the position-limiting member (7) clamp the second shaft (4).

6. The machine part for laser demarcation device according to claim 1, wherein
an inner ring of the bearings (5) mounted on the first shaft (3) is fixed to the first shaft (3) by glue; and/or
an inner ring of the bearings (5) mounted on the second shaft (4) is fixed to the second shaft (4) by glue.

7. The machine part for laser demarcation device according to claim 1, wherein
an inner ring of the bearings (5) mounted on the first shaft (3) is fixedly connected to the first shaft (3) through a bearings pressure ring (9); and/or
an inner ring of the bearings (5) mounted on the second shaft (4) is fixedly connected to the second shaft (4) through the bearings pressure ring (9).

8. The machine part for laser demarcation device according to claim 7, wherein
the corresponding bearings pressure ring (9) is connected to the first shaft (3) by threads; and/or
the corresponding bearings pressure ring (9) is connected to the second shaft (4) by threads.

9. The machine part for laser demarcation device according to claim 1, wherein
an outer ring of the corresponding bearings (5) is fixed to the hanger (1) by glue; and/or
an outer ring of the corresponding bearings (5) is fixed to the connecting arms (21) by glue.

10. The machine part for laser demarcation device according to claim 9, wherein
a hole (8) for glue dropping is provided on the hanger (1) and/or the connecting arms (21) for communicating with a corresponding bearings mounting hole for mounting the bearings (5).
